(19) United States
(12) Patent Application Publication
(10) Pub. No.: US 2026/0088924 A1
(43) Pub. Date: Mar. 26, 2026

(54) Computer-Implemented Method for Time Validation in a Network System

(71) Applicant: Bayerische Motoren Werke Aktiengesellschaft, Muenchen (DE)

(72) Inventors: Karl BUDWEISER, Muenchen (DE); Christoph GOLLOB, Karlsfeld (DE); Simon ZENKER, Muenchen (DE)

(21) Appl. No.: 19/319,849

(22) Filed: Sep. 5, 2025

(30) Foreign Application Priority Data
Sep. 25, 2024 (DE) 10 2024 127 696.7

(51) Int. Cl. H04J 3/06

(52) U.S. Cl. CPC H04J 3/0658

(57) ABSTRACT

A method for time validation in a network system includes receiving, in a network component, a first global time (t1) of the network system at a first local time (T1) of the network component for a synchronization event, forwarding, by the network component, a second global time (t2) of the network system at a second local time (T2) of the network component for the synchronization event, determining, by the network component or a validation unit, a first difference (Δ1) between the second local time (T2) and the first local time (T1), and performing, by the validation unit, a time validation with respect to the network component based on the first difference (Δ1).

### CROSS REFERENCE TO RELATED APPLICATION

This application claims priority under 35 U.S.C. § 119 from German Patent Application No. 10 2024 127 696.7, filed Sep. 25, 2024, the entire disclosure of which is herein expressly incorporated by reference.

### BACKGROUND AND SUMMARY

The present disclosure relates to a computer-implemented method for time validation in a network system, a storage medium for carrying out the method, and a network system. The present disclosure relates in particular to a time validation of a security-relevant time synchronization in a network system.

In networked systems, the global time and local time are central to the synchronization of devices and process coordination. However, the mechanisms currently used to validate time synchronization have proven to be inadequate in certain scenarios and fail to reliably detect errors in forwarding the time, for example in a switch with boundary clock.

Current validation approaches are often based on the assumption that there is a biunique (bijective) mapping between the local time of all ports (master and slave ports) and the global time. This assumption of bijectivity, however, proves problematic in practice, since it is not always valid. For example, an overflow of the local clock of a port can lead to persistent errors, because the mapping is permanently disrupted, but these errors are erroneously only detected as temporary (transient) errors. Such undetected or misdiagnosed problems significantly affect the accuracy and reliability of time synchronization in networked systems.

It is an object of the present disclosure to specify a computer-implemented method for time validation in a network system, a storage medium for carrying out the method, and a network system that enable reliable time validation. In particular, it is an object of the present disclosure to detect an overflow of a local clock.

This object is achieved by the subject matter of the independent claims. Advantageous configurations are specified in the dependent claims.

According to an independent aspect of the present disclosure, a computer-implemented method for time validation in a network system is specified. The method comprises receiving, in a network component, a first global time of the network system at a first local time of the network component for a synchronization event; forwarding, by the network component, a second global time of the network system at a second local time of the network component for the synchronization event; determining, by the network component or a validation unit, a first difference between the second local time and the first local time; and performing, by the validation unit, a time validation with respect to the network component based on the first difference.

According to the present disclosure, a temporal relation of a local clock is determined by determining a difference in the local time at two defined time points. In other words, an offset of the local time is determined, which measures the time from receiving the synchronization event to forwarding it. This relation or time difference must meet certain conditions in the fault-free case, such as being within a specific interval and/or always having a positive value. If this is not the case, a fault can be detected. For example, an overflow of the local clock of the output port can be detected if the difference is negative. This makes it possible to correctly identify a permanent error and to avoid misclassifying it as a temporary (transient) error. As a result a reliable time validation is made possible.

The network component and the validation unit may comprise software components/algorithms that are designed to run on at least one processor and thereby perform the functionalities of the respective component or unit.

The term “clock” refers to a time measurement in the network system to coordinate and synchronize actions.

The local clock is the internal clock of the network component, such as a switch, router, server, or processor. This clock indicates the local time specific to the respective network component. Each network component has its own local clock, which is driven by an internal clock generator (often in the form of a crystal oscillator).

The global clock is a central, synchronized time source used by all network components in the network system as a reference. The global clock represents a universal time base or global time which is provided by a trusted source, such as a master clock in the network system.

The term “synchronization event” refers to a specific event for which the local clock of a network component is measured with high precision and matched with the synchronous or global time, in order to then adjust the local instance to global time with the aim of minimizing time differences and ensuring time consistency (synchronicity) throughout the network.

Preferably, the network component is a switch. A switch (network switch) is a device used in the network system to efficiently route data packets between different network components. The switch acts as an intelligent distributor that analyzes and controls network traffic by targeting packets to the correct network component on the network.

Preferably, the switch is a switch with boundary clock. A switch with boundary clock is a network switch that is capable of actively supporting time synchronization in a distributed network, in particular when using the Precision Time Protocol (PTP) according to the IEEE 1588 standard or gPTP according to IEEE 802.1AS. Unlike simple network switches that would simply forward PTP messages, a boundary-clock switch takes an active role in synchronizing the time between the various devices on the network to improve achievable synchronization accuracy.

Preferably, the validation unit is a central component in the network system. In particular, the validation unit can be centrally provided and receive time information from a wide range of network components to perform time validation in a centralized manner.

Preferably, the first difference is defined as follows:

$$Δ 1 = T 2 - T 1$$

Here, T1 denotes the first local time at which the network component receives the first global time of the network system. T2 denotes the second local time at which the network component forwards the second global time.

Preferably, the validation unit is designed to detect an overflow of the local time of the network component based on the first difference. An overflow of the local time of a network component refers to a situation where the internal clock of a network component, such as a switch, reaches its maximum time limit and then jumps back to zero or a very low value without compensating/recording that overflow.

An overflow occurs in particular when the hardware-based representation of the local time in a digital system is stored with a certain number of bits (register) and this capacity is exhausted. For an adequate handling of local time, register overflows in the software must be detected, counted and taken into account accordingly. A multi-port digital system such as a switch can even have a separate hardware-based local time for each port, which must be correctly converted to a local time valid for the entire system in order to distribute the global time throughout the system. Without the detection mechanism described, undetected errors can occur in any version of the system.

The network component preferably determines the second global time by adding a difference between the second local time and the first local time to the first global time received. In other words, the global timestamp received via a slave port, for example, can be manipulated and forwarded via a master port, for example.

Preferably, the validation unit determines a positive time validation result, i.e. no error, if the first difference or the magnitude of the first difference is less than a threshold. For example, for a specific network component, it can be assumed that forwarding the global time usually takes a certain period of time, such as approximately 100 ms. If the first difference or its magnitude is within this limit, it is safe to assume that there is no error present. The threshold can be set appropriately. In particular, the threshold may be greater than the usual error-free forwarding time, but less than a time that would indicate an error.

Preferably, the validation unit determines a negative time validation result, i.e. the presence of an error, if the first difference or the magnitude of the first difference is greater than a threshold. For example, as explained earlier, for a specific network component it can be assumed that forwarding the global time usually takes a certain period of time, such as approximately 100 ms. If the first difference or its magnitude is outside this range (e.g. 1 s or more), it can be assumed that there is an error present, such as an overflow of the local clock.

Preferably, the threshold of 500 ms or 1 s is designed for the hardware-based representation of the local time.

The validation unit determines a negative time validation result, i.e. the presence of an error, if the first difference is negative. A negative first difference means that the second local time is less than the first local time or that the first local time is greater than the second local time, which is a reliable indication of an overflow of the local clock, for example.

Preferably, the method further comprises determining, by the network component or the validation unit, a second difference between the second global time and the first global time.

Preferably, the second difference is defined as follows:

$$Δ 2 = t 2 - t 1$$

Here, t1 denotes the first global time that the network component receives at the first local time. t2 denotes the second global time that the network component forwards at the second local time.

Preferably, the time validation with respect to the network component is also carried out based on the second difference. Taking into account the second difference may serve as an additional level of security or to validate the first difference and the conclusions drawn from it. This introduces a further check to confirm the reliability of the first difference and to detect potential errors at an early stage.

Preferably, the network component comprises a plurality of local clocks, wherein the time validation is carried out separately for each local clock. In particular, a digital system with multiple ports, such as a switch, can have a separate hardware-based local time for each port, which must be correctly converted to a local time valid for the entire system in order to distribute the global time throughout the system.

Preferably, the method is used in safety-critical applications, such as the automated driving of vehicles. In particular, a precise time synchronization in such applications is of crucial importance, so that the error detection according to the present disclosure can contribute to the safe and reliable execution of these safety-critical processes.

Preferably, the method is applied in the automated driving of a vehicle, in particular a motor vehicle. To carry out the automated driving, a large number of components such as sensors, control units, switches etc. is provided, which are connected to each other in a network. The time validation according to the present disclosure contributes to the safe and reliable operation of this network and thus to safe and reliable automated driving.

The term “automated driving” is understood in the context of the document to mean driving with automated longitudinal and/or transverse guidance. Autonomous driving can consist, for example, of driving for a long time on the freeway or time-limited driving during parking. The term “autonomous driving” covers automated driving with any degree of automation. Examples of degrees of automation include assisted, partially automated, conditionally automated, highly automated and fully automated driving (with increasing degrees of automation). The five automation levels listed above correspond to SAE levels 1 to 5 of the SAE J3016 standard (SAE—Society of Automotive Engineering) according to the version published on 30 Apr. 2021.

According to another independent aspect of this disclosure, a software (SW) program is specified. The SW program can be designed to be executed on one or more processors, and thereby to carry out the method for time validation in a network system described in this document.

According to another independent aspect of the present disclosure, a storage medium is specified. The storage medium can comprise a SW program which is designed to be executed on one or more processors and thereby carry out the method for time validation in a network system described in this document.

According to another independent aspect of this disclosure, a piece of software with program code is specified. The software is designed to carry out the method for time validation in a network system when the software runs on one or more software-controlled devices.

According to another independent aspect of the present disclosure, a network system is specified. The network system comprises processors, and memories which are connected to the processors and contain instructions that the processors can execute in order to carry out the method for time validation in a network system described in this document.

A processor or processor module is a programmable computing mechanism, i.e. a machine or an electronic circuit, which controls other elements according to commands passed to it and in doing so drives an algorithm (process).

According to another independent aspect of this disclosure, a vehicle, in particular a motor vehicle, is specified. The vehicle comprises the network system according to the embodiments of the present disclosure.

The term “vehicle” includes cars, trucks, buses, goods vehicles, motor homes, motorcycles, etc., which are used for transporting people, goods, etc. In particular, the term covers motor vehicles for the transport of passengers.

Exemplary embodiments of the disclosure are shown in the drawings and will be described in more detail in the following.

Other objects, advantages and novel features of the present disclosure will become apparent from the following detailed description of one or more preferred embodiments when considered in conjunction with the accompanying drawings.

### BRIEF DESCRIPTION OF THE DRAWINGS

FIG. 1 shows a flowchart of a method for time validation in a network system according to embodiments of the present disclosure, and

FIG. 2 shows schematically a network system according to embodiments of the present disclosure.

### DETAILED DESCRIPTION OF THE DRAWINGS

In the following, unless otherwise noted, the same reference signs are used for identical and equivalent elements.

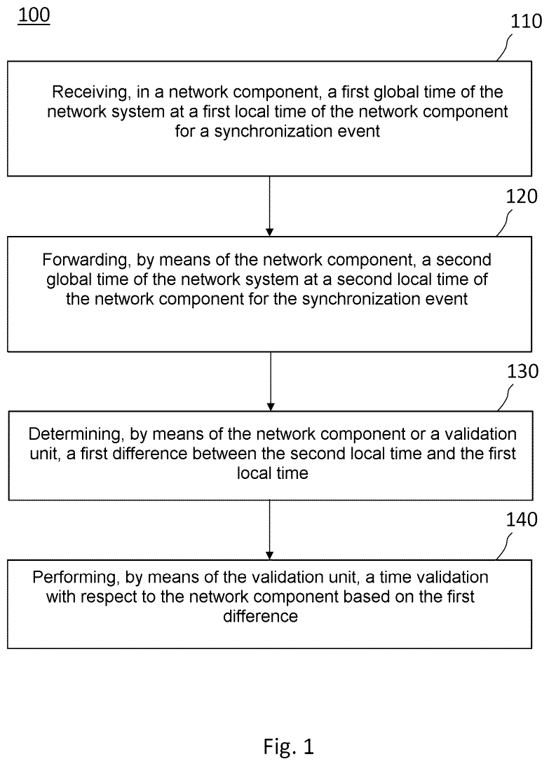

FIG. 1 shows a flowchart of a method 100 for time validation in a network system 200 according to embodiments of the present disclosure.

The method 100 comprises in block 110 receiving, in a network component, a first global time of the network system at a first local time of the network component for a synchronization event; in block 120 forwarding, by the network component, a second global time of the network system at a second local time of the network component for the synchronization event; in block 130 determining, by the network component or a validation unit, a first difference between the second local time and the first local time; and in block 140 performing, by the validation unit, a time validation with respect to the network component based on the first difference.

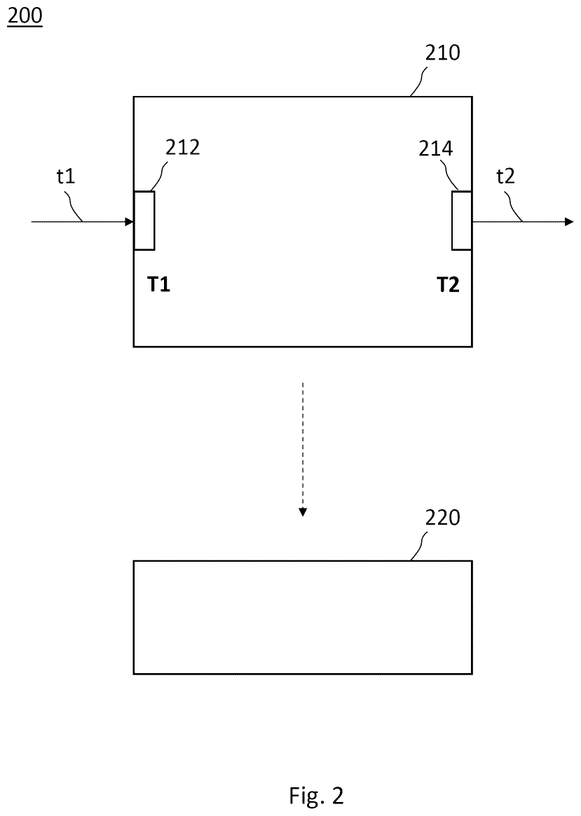

An exemplary detailed embodiment of the method 100 is described below with reference to FIG. 2.

FIG. 2 shows a schematic view of a network system 200 according to embodiments of the present disclosure.

In the example of FIG. 2, a network component 210 and a validation unit 220 are shown.

The network component 210 may be a switch or network switch, but this disclosure is not limited to these.

The validation unit 220 can be a central component in the network system 200. In particular, the validation unit 220 can be centrally provided and receive time information from a wide range of network components to perform time validation in a centralized manner. The receipt of the time information by the validation unit 220 is represented schematically in FIG. 2 by the dashed arrow. However, the present disclosure is not limited to this and a decentralized check (“on-site”) or a centralized and decentralized check are also conceivable.

The network component 210 comprises a local clock that provides or specifies the local time T1, T2 which is valid specifically for the network component 200. Each network component in the network system 200 can comprise its own local clock, which is driven by an internal clock generator (often in the form of a crystal oscillator).

The network component 210 further comprises at least one first port 212, which is designed to receive the first global time t1 of the network system 200 or the global clock at a first local time T1 of the network component 210. For example, the at least one first port 212 can be a slave port.

The network component 220 further comprises at least one second port 214, which is designed to forward the second global time t2 of the network system 200 or the global clock, for example to other network components, at a second local time T2 of the network component 210. For example, the at least one second port 212 can be a master port.

The global clock is a central, synchronized time source used by all network components in the network system 200 as a reference. The global clock represents a universal time base or global time which is provided by a trusted source, such as a master clock in the network system 200.

In some embodiments the network component 210 determines the second global time t2 by adding a difference between the second local time T2 and the first local time T1 to the first global time t1 received:

$$t 2 = t 1 + ( T 2 - T 1 )$$

This allows the global timestamp received via the slave port 212, for example, to be manipulated and forwarded via the master port 214, for example.

The network component 210 or the validation unit 220 determines a first difference between the second local time T1 and the first local time T1:

$$Δ 1 = T 2 - T 1$$

The expression “difference between local times” should be understood to mean that the first local time T1 is subtracted from the second local time T2 (see above), or that the second local time is subtracted from the first local time (not shown).

The validation unit 220 then performs a time validation with respect to the network component 210 based on the first difference Δ1.

In some embodiments, the error is an overflow of the local time or local clock of the network component 210. The term “overflow” refers to a situation where the internal clock of the network component 210 reaches its maximum time limit and then jumps back to zero or a very low value without compensating/recording that overflow.

In some embodiments, the validation unit 220 determines a positive time validation result, i.e. no error, if the first difference Δ1 or the magnitude of the first difference Δ1 is less than a threshold:

$$Δ 1 < threshold$$

For example, for a specific network component, it can be assumed that in the extreme case forwarding the global time takes a certain period of time, such as approximately 100 ms. If the first difference Δ1 or its magnitude is within this range, it is safe to assume that there is no error present. The threshold can be set appropriately. In particular, the threshold may be greater than the usual error-free forwarding time, but less than a time that would indicate an error.

In some embodiments, the validation unit 220 determines a negative time validation result, i.e. the presence of an error, if the first difference Δ1 or the magnitude of the first difference Δ1 is greater than the threshold:

$$Δ 1 > threshold$$

For example, as explained earlier, for a specific network component it can be assumed that forwarding the global time usually takes a certain period of time, such as approximately 100 ms. If the first difference or its magnitude is outside this range (e.g. Is or more), it can be assumed that there is an error, such as an overflow of the local clock.

Preferably, the threshold is 500 ms or 1 s, but the present disclosure is not limited to this, especially since the fault tolerance time remains unaffected by it.

In addition or alternatively, the validation unit 200 determines a negative time validation result, i.e. the presence of an error, if the first difference Δ1 is negative:

$$Δ 1 < 0$$

A negative first difference Δ1 means that the second local time T2 is less than the first local time or that the first local time T1 is greater than the second local time T2, which is a reliable indication of an overflow of the local clock, for example.

In some embodiments, the method 100 further comprises determining, by the network component 210 or the validation unit 220, a second difference Δ2 between the second global time t2 and the first global time t1:

$$Δ 2 = t 2 - t 1$$

Here, t1 denotes the first global time that the network component 210 receives at the first local time T1. t2 denotes the second global time that the network component 210 forwards at the second local time T2.

In some embodiments, the time validation with respect to the network component 210 is also carried out based on the second difference Δ2. Taking into account the second difference Δ2 may serve as an additional level of security or to validate the first difference Δ1 and the conclusions drawn from it. This introduces a further check to confirm the reliability of the first difference Δ1 and to detect potential errors at an early stage.

The criteria for the second difference Δ2 can be defined in the same way as the criteria for the first difference Δ1. In particular, a second difference Δ2 which is greater than a threshold may indicate an error. Similarly, a negative second difference Δ2 may indicate an error, in particular an overflow.

In some embodiments, the network component 210 comprises a plurality of local clocks, wherein the time validation is carried out separately for each local clock. In particular, a digital system with multiple ports, such as a switch, can have a separate hardware-based local time for each port, which must be correctly converted to a local time valid for the entire system in order to distribute the global time throughout the system.

In some embodiments, the method 100 is used in safety-critical applications, such as the automated driving of vehicles. To carry out the automated driving, a large number of components such as sensors, control units, switches etc. is provided, which are connected to each other in a network. The time validation according to the present disclosure contributes to the safe and reliable operation of this network and thus to safe and reliable automated driving.

According to the present disclosure, a temporal relation of a local clock is determined by determining a difference in the local time at two defined time points. In other words, an offset of the local time is determined. This relation or time difference must meet certain conditions in the fault-free case, such as being within a specific interval and/or always having a positive value. If this is not the case, a fault can be detected. For example, an overflow of the local clock can be detected if the difference is negative. This makes it possible to correctly identify a permanent error and to avoid misclassifying it as a temporary (transient) error. As a result a reliable time validation is made possible.

Although the present disclosure has been illustrated and explained in greater detail using preferred exemplary embodiments, the disclosure is not restricted by the examples disclosed and other variations can be derived therefrom by the person skilled in the art without departing from the scope of protection of the present disclosure. It is therefore clear that a large number of variations exists. It is also clear that exemplary embodiments cited are really only examples which are not in any way to be understood as limiting, for example, the scope of protection, the application possibilities or the configuration of the disclosure. On the contrary, the preceding description and the description of the figures enable the person skilled in the art to put the exemplary embodiments into practice, wherein the person skilled in the art, knowing the disclosed idea, can make various changes, for example with regard to the function or arrangement of individual elements mentioned in an exemplary embodiment, without departing from the scope of protection which is defined by the claims and their legal equivalents, such as further explanations in the description.

The foregoing disclosure has been set forth merely to illustrate the present disclosure and is not intended to be limiting. Since modifications of the disclosed embodiments incorporating the spirit and substance of the present disclosure may occur to persons skilled in the art, the invention should be construed to include everything within the scope of the appended claims and equivalents thereof.

What is claimed is:

1. A computer-implemented method for time validation in a network system, comprising:
receiving, in a network component, a first global time of the network system at a first local time (T1) of the network component for a synchronization event;
forwarding, by the network component, a second global time (t2) of the network system at a second local time (T2) of the network component for the synchronization event;
determining, by the network component or a validation unit, a first difference (Δ1) between the second local time (T2) and the first local time (T1); and
performing, by the validation unit, a time validation with respect to the network component based on the first difference (Δ1).

2. The method according to claim 1,
wherein the network component is a switch with a boundary clock.

3. The method according to claim 1, comprising:
detecting, by the validation unit, an overflow of the local time of the network component based on the first difference (Δ1).

4. The method according to claim 1, comprising:
determining, by the network component, the second global time (t2) by adding a difference between the second local time (T2) and the first local time (T1) to the first global time (t1) received.

5. The method according to claim 1, comprising:
determining, by the validation unit, a positive time validation result in response to the first difference (Δ1) or a magnitude of the first difference (Δ1) being less than a threshold; and/or
determining, by the validation unit, a negative time validation result in response to the first difference (Δ1) or the magnitude of the first difference (Δ1) being greater than the threshold.

6. The method according to claim 1, comprising:
determining, by the validation unit, a negative time validation result in response to the first difference (Δ1) being negative.

7. The method according to claim 1, comprising:
determining, by the network component or the validation unit, a second difference (Δ2) between the second local time (t2) and the first local time (t1),
wherein the time validation with respect to the network component is also carried out based on the second difference (Δ2).

8. The method according to claim 1, comprising:
carrying out the time validation separately for each local clock of a plurality of local clocks of the network component.

9. A non-transitory storage medium having stored thereon a software program that, when executed by one or more processors, causes the one or more processors to perform a method comprising:
receiving, in a network component, a first global time of a network system at a first local time (T1) of the network component for a synchronization event;
forwarding, by the network component, a second global time (t2) of the network system at a second local time (T2) of the network component for the synchronization event;
determining, by the network component or a validation unit, a first difference (Δ1) between the second local time (T2) and the first local time (T1); and
performing, by the validation unit, a time validation with respect to the network component based on the first difference (Δ1).

10. A network system, comprising:
at least one processor configured to:
receive a first global time of the network system at a first local time (T1) of a network component for a synchronization event;
forward a second global time (t2) of the network system at a second local time (T2) of the network component for the synchronization event;
determine a first difference (Δ1) between the second local time (T2) and the first local time (T1); and
perform a time validation with respect to the network component based on the first difference (Δ1).

11. The network system according to claim 10,
wherein the network component is a switch with a boundary clock.

12. The network system according to claim 10,
wherein the at least one processor is configured to:
detect an overflow of the local time of the network component based on the first difference (Δ1).

13. The network system according to claim 10,
wherein the at least one processor is configured to:
determine the second global time (t2) by adding a difference between the second local time (T2) and the first local time (T1) to the first global time (t1) received.

14. The network system according to claim 10,
wherein the at least one processor is configured to:
determine a positive time validation result in response to the first difference (Δ1) or a magnitude of the first difference (Δ1) being less than a threshold; and/or
determine a negative time validation result in response to the first difference (Δ1) or the magnitude of the first difference (Δ1) being greater than the threshold.

15. The network system according to claim 10,
wherein the at least one processor is configured to:
determine a negative time validation result in response to the first difference (Δ1) being negative.

16. The network system according to claim 10,
wherein the at least one processor is configured to:
determine a second difference (Δ2) between the second local time (t2) and the first local time (t1),
wherein the time validation with respect to the network component is also carried out based on the second difference (Δ2).

17. The network system according to claim 10,
wherein the at least one processor is configured to:
carry out the time validation separately for each local clock of a plurality of local clocks of the network component.
